(19) United States
(12) Patent Application Publication
(10) Pub. No.: US 2013/0262855 A1
(43) Pub. Date: Oct. 3, 2013

(54) DOCUMENT ENCRYPTING SYSTEM AND METHOD USING SAME

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventor: PENG WANG, Shenzhen (CN)

(73) Assignees: HON HAI PRECISION INDUSTRY CO., LTD., New Taipei (TW); Fu Tai Hua Industry (Shenzhen) Co., Ltd., Shenzhen (CN)

(21) Appl. No.: 13/851,978

(22) Filed: Mar. 28, 2013

(30) Foreign Application Priority Data
Mar. 28, 2012 (CN) 201210085760.8

(51) Int. Cl. H04L 29/06

(52) U.S. Cl. CPC H04L 63/0428
USPC 713/153

(57) ABSTRACT

A document encrypting system in an electronic apparatus includes a communicating module, an encoding module, a decoding module, and a deleting module. The communicating module builds a communication with the network storage device, downloads the encryption algorithm from the network storage device, and stores the encryption algorithm in the local storage device. The encoding module employs the encryption algorithm to encode the document. The decoding module employs the encryption algorithm to decode the document. The deleting module deletes the encryption algorithm stored in the local storage device.

### TECHNICAL FIELD

The disclosure generally relates to encryption technologies, and particularly, to a document encrypting system and method using the document encrypting system.

### DESCRIPTION OF RELATED ART

An algorithm saved in a local machine usually can be used to encrypt a confidential document. However, people who have access to the local machine may decode the algorithm to read the confidential document, which may influence confidentiality of the document.

Therefore, it is desirable to provide a means, which can overcome the above-mentioned problems.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic apparatus.

FIG. 2 is a flowchart of an exemplary embodiment of a document encrypting method.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable median include CDs, DVDs, BLU-RAY, flash memory, and hard disk drives.

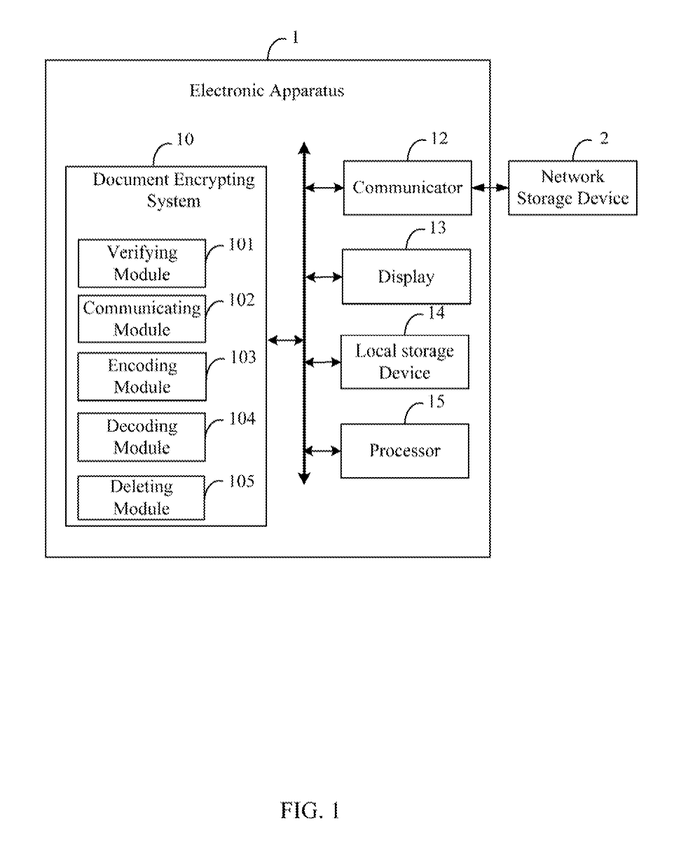

FIG. 1 is a block diagram of one embodiment of an electronic apparatus 1. The electronic apparatus 1 includes a document encrypting system 10. In one embodiment, the electronic apparatus 1 communicates and exchanges data with a network storage device 2 via a wireless network or a wired network. The electronic apparatus 1 includes a communicator 12, a display 13, a local storage device 14, and at least one processor 15. The communicator 12, the display 13, the local storage device 14, and the at least one processor 15 are directly or indirectly electronically connected, for data exchange. In this embodiment, the electronic apparatus 1 may be, but is not limited to, a computer or a mobile intelligent terminal, such as a tablet computer or a cellular phone.

The network storage device 2 may be, but is not limited to, an e-mail server or a cloud server. The network storage device 2 is accessed by verifying a user identification and a corresponding user password. The network storage device 2 stores an encryption algorithm.

The local storage device 14 may be, but is not limited to, a hard disk, or a dedicated memory, such as an EPROM, HDD, or flash memory. The local storage device 14 stores a document to be encrypted, among other data.

The communicator 12 may be, but is not limited to a wired network adapter or a wireless network adapter. The communicator 12 communicates and exchanges data with the network storage device 2.

The document encrypting system 10 includes a verifying module 101, a communicating module 102, an encoding module 103, a decoding module 104, and a deleting module 105. Computerized codes of the document encrypting system 10 can be embedded into an operating system of the electronic apparatus 1, or stored in the local storage device 14 and executed by the processor 15.

The verifying module 101 displays a window on the display 13, the window allowing the user to input the user identification and the user password when the electronic apparatus 1 communicates with the network storage device 2.

The communicating module 102 controls the communicator 12 to build a communication with the network storage device 2 when the user identification matches with the user password. The communicating module 102 downloads an encryption algorithm from the network storage device 2 when the document is encrypted. It is understood that the communicator 12 communicates and exchanges data with the network storage device 2 via the wireless network or the wired network.

The encoding module 103 employs the encryption algorithm to encode the document. In this embodiment, the encryption algorithm is a partition-encoding algorithm. The encryption algorithm divides the encrypted document into a number of unreadable sub-documents. The encryption algorithm also can randomly cut a part of the data from the document to form an additional text. The communicating module 102 uploads the additional text to the network storage device 2 after the document has been encrypted. Therefore, even though the number of unreadable sub-documents are decrypted by a hacker, the document cannot be displayed completely.

The decoding module 104 employs the encryption algorithm to decode the unreadable sub-documents and form a complete document by combining the decoded sub-documents with the additional text. The communicating module 102 downloads the additional text from the network storage device 2 when the encrypted document is decoded.

The deleting module 105 is configured to delete the encryption algorithm and/or the additional text stored in the local storage device 14.

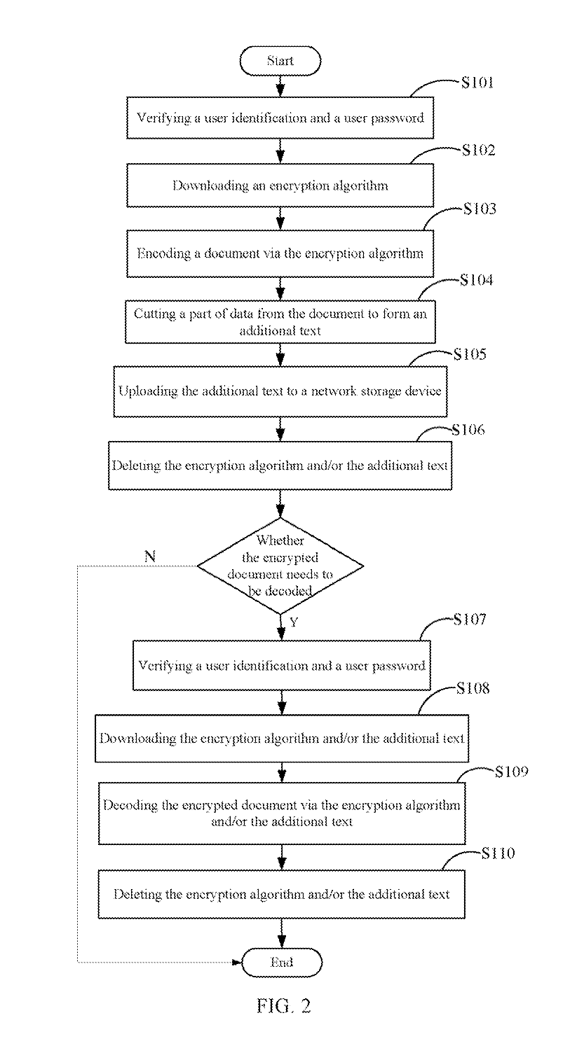

FIG. 2 is a flowchart of an exemplary embodiment of a document encrypting method. Depending on the embodiment, additional steps may be added, others deleted, and the ordering of the steps may be changed.

In step S101, the verifying module 101 displays the window on the display 13 allowing the user to input the user identification and the user password when the document is encrypted.

In step S102, the communicating module 102 builds a communication with the network storage device 2 when the user identification matches with the user password. The communicating module 102 downloads the encryption algorithm from the network storage device 2 and stores the encryption algorithm in the local storage device 14.

In step S103, the encoding module 103 employs the encryption algorithm to encode the document. In this embodiment, the encryption algorithm is a partition encoding algorithm. The encrypted document is divided into a number of unreadable sub-documents by the encryption algorithm. The encoding module 103 stores the unreadable sub-documents in the local storage device 14.

In step S104, the encoding module 103 randomly cuts a part of data from the document to form the additional text.

In step S105, the communicating module 102 uploads the additional text to the network storage device 2.

In step S106, the deleting module 105 deletes the encryption algorithm and/or the additional text stored in the local storage device 14 after finishing the step S105.

In step S107, the verifying module 101 displays the window allowing the user to input the user identification and the user password when the encrypted document is decoded.

In step S108, the communicating module 102 builds a communication with the network storage device 2 when the user identification matches the user password. The communicating module 102 downloads the encryption algorithm and/or the additional text from the network storage device 2 and stores the encryption algorithm in the local storage device 14.

In step S109, the decoding module 104 employs the encryption algorithm to decode the unreadable sub-documents and forms the complete document by combining the decoded sub-documents with the additional text.

In step S110, the deleting module 105 deletes the encryption algorithm and the additional text stored in the local storage device 14 after the encrypted document has been decoded.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An electronic apparatus communicating and exchanging data with a network storage device, the network storage device storing an encryption algorithm, the electronic apparatus comprising:
a local storage device that stores at least one document; and
a document encrypting system, comprising:
a communicating module that downloads the encryption algorithm from the network storage device, and stores the encryption algorithm in the local storage device;
an encoding module that employs the encryption algorithm to encode the at least one document;
a decoding module that employs the encryption algorithm to decode the at least one document; and
a deleting module that deletes the encryption algorithm stored in the local storage device.

2. The electronic apparatus of claim 1, wherein the encryption algorithm is a partition encoding algorithm, the encryption algorithm divides the encrypted document into a plurality of unreadable sub-documents, and the unreadable sub-documents are stored in the local storage device.

3. The electronic apparatus of claim 2, wherein the encryption algorithm randomly cuts a part of data from the at least one document to form an additional text.

4. The electronic apparatus of claim 3, wherein the communicating module uploads the additional text to the network storage device after the at least one document has been encrypted.

5. The electronic apparatus of claim 3, wherein the encryption algorithm decodes the unreadable sub-documents and forms a complete document by combining the decoded sub-documents with the additional text.

6. The electronic apparatus of claim 1, wherein the electronic apparatus communicates with the network storage device via a wireless network.

7. The electronic apparatus of claim 1, wherein the electronic apparatus communicates with the network storage device via a wired network.

8. The electronic apparatus of claim 1, wherein the network storage is selected from the group consisting of an e-mail serve and a cloud drive.

9. A document encrypting method being performed by execution of computer readable program code by a processer of an electronic apparatus, the electronic apparatus communicating and exchanging data with a network storage device, the network storage device storing an encryption algorithm, the electronic apparatus comprising a local storage device storing a document, the method comprising:
communicating with the network storage device when the document is encrypted;
downloading the encryption algorithm and storing the encryption algorithm in the local storage device;
encoding the document via the encryption algorithm; and
deleting the encryption algorithm stored in the local storage device after finishing encoding the document.

10. The method as claimed in claim 9, further comprising:
communicating with the network storage device when the encrypted document is decoded;
downloading the encryption algorithm and storing the encryption algorithm in the local storage device;
decoding the document via the encryption algorithm; and
deleting the encryption algorithm stored in the local storage device after finishing decoding the document.

11. The method as claimed in claim 9, the network storage device is accessed by verifying a user identification and a corresponding user password, the document encrypting method further comprising:
displaying a pop-up window to ask the user to input the user identification and the user password before communicating with the network storage device.

12. The method as claimed in claim 9, wherein the encryption algorithm is a partition encoding algorithm, and the step of decoding the document via the encryption algorithm comprises: dividing the encrypted document into a plurality of unreadable sub-documents, and storing the unreadable sub-documents in the local storage device.

13. The method as claimed in claim 12, wherein the step of decoding the document via the encryption algorithm further comprises a step of randomly cutting a part of data from the document to form an additional text and storing the additional text in the local storage device.

14. The method as claimed in claim 13, further comprising:
uploading the additional text to the network storage.

15. The method as claimed in claim 14, further comprising:
deleting the additional text stored in the local storage device.
